(19) United States
(12) Patent Application Publication
(10) Pub. No.: US 2008/0079288 A1
(43) Pub. Date: Apr. 3, 2008

(54) Front end module with integral upper frame/crush rail

(75) Inventor: Jack V. Henderson, Rochester Hills, MI (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/528,867

(22) Filed: Sep. 28, 2006

(51) Int. Cl. B62D 25/08

(52) U.S. Cl. 296/187.09

(57) ABSTRACT

The present invention relates to a front end module for absorbing crash energy including a body and a reinforcement member. The body has at least one connector. The reinforcement member is connected to the front end module, and has at least one extension. The at least one extension is connected to the at least one connector, and the at least one extension absorbs crash energy.

### FIELD OF THE INVENTION

The present invention relates to a front end module with an integrated crash rail.

### BACKGROUND OF THE INVENTION

Safety is always a priority with the design and construction of motorized vehicles. The ability for a vehicle to encounter a collision with another vehicle, telephone pole, or other object while avoiding injury to the driver or passengers has become increasingly important.

Often times when adding reinforcement to the vehicle in order to improve strength and resistance for impact with other objects, the weight of the vehicle is increased, which in turn can reduce fuel economy and hinder performance. Although adding strength to the vehicle frame may make the vehicle more resistant to impact, it does not necessarily absorb the energy from the impact. Thus, in order for the additional reinforcement to properly distribute the crash energy it must be constructed in a certain manner. Further, adding additional components for a single purpose can reduce the efficiency or economic value of the vehicle.

Therefore, it is desirable to develop a structure that adds strength and resistance to impact while the additional structure can also be used for other purposes.

### SUMMARY OF THE INVENTION

The present invention relates to a front end module for absorbing crash energy including a body and a reinforcement member. The body has at least one connector. The reinforcement member is connected to the front end module and has at least one extension. The at least one extension is connected to the at least one connector, and the at least one extension absorbs crash energy.

### BRIEF DESCRIPTION OF THE DRAWINGS

The present invention will become more fully understood from the detailed description and the accompanying drawings, wherein:

FIG. 1 is an exploded perspective view of a front end module connected to a body in accordance with an embodiment of the present invention;

FIG. 2 is an exploded perspective view of a connection between the front end module and the body in accordance with an embodiment of the present invention; and

FIG. 3 is an exploded perspective view of a connection between the front end module and the body in accordance with an embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

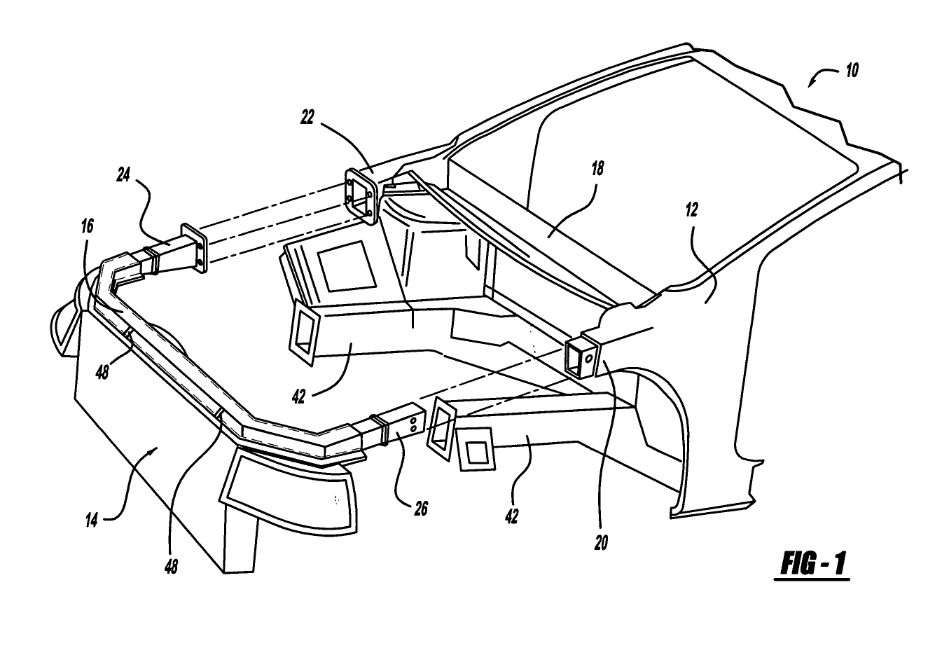

Referring to FIG. 1, the components of a motorized vehicle incorporating the present invention are generally shown at 10. A body 12 has various connectors, ports, bores, holes, and other parts to support the various components of the vehicle 10. A front end module generally indicated at 14 has a reinforcement member 16 which can be used for supporting a hood (not shown) of the vehicle 10 and can comply with any necessary hood slam requirements, hood latch requirements, or the like.

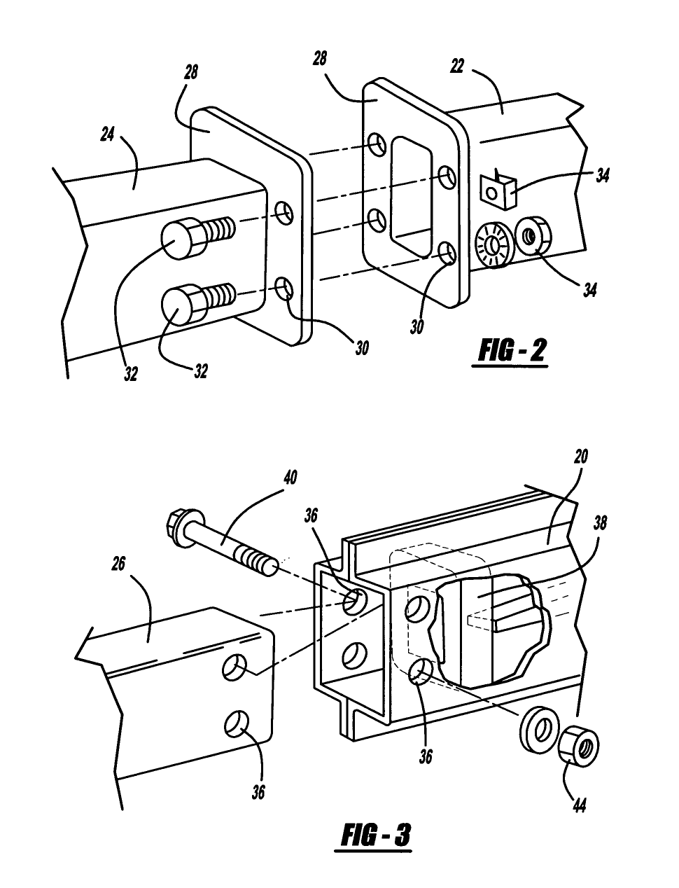

The front end module 14 also has an upper front cross car segment 18. The upper front cross car segment 18 includes a set of connectors 20, 22. The reinforcement member 16 has extensions or attachments 24, 26 which attach to the connectors 20, 22. The extensions 24, 26 can be attached to the connectors 20, 22 in various ways. One embodiment can be the attachment between connector 22 and extension 24, shown in FIG. 2; another embodiment can be the attachment between connector 20 and extension 26, shown in FIG. 3.

In an embodiment shown in FIG. 2, the extension 24 and the connector 22 can each have a connection area 28 having at least one hole 30. The connection area 28 creates a flat surface around the circumference of the connector 22 and extension 24. Thus, the flat surfaces of the connection area 28 creates a surface area where the connector 22 and extensions 24 can be attached. To connect the extension 24 to the connector 22, at least one fastener 32 can be inserted through at least one hole 30 and is locked in place by a fastener receiver 34. By way of explanation and not limitation, the fastener 32 can be a threaded screw or the like, and the fastener receiver 34 can be a “J” or “U” nut, a lock nut used with a lockwasher, or the like.

In an embodiment shown in FIG. 3, the connector 20 is adapted to receive at least a portion of the extension 26. The connector 20 can have a larger diameter than the extension 26. However, it should be appreciated that the extension 26 can have a larger diameter than the connector 20, such that the connector 20 is inserted into the extension 26. The extension 26 and connector 20 both have holes 36 which align with one another when the extension 26 is inserted into the connector 20 and rests against an internal stop 38. The internal stop 38 serves to automatically align the holes 36 in the extension 26 and connector 20; thus preventing the extension 26 from extending too far into the connector 20. The internal stop 38 also ensures the extension 26 is inserted into the connector 20 far enough. A fastener 40 is inserted through each set of aligned holes 36 and is held in place by a fastener receiver 44. By way of explanation and not limitation, the fastener 40 can be a bolt, screw, or the like, and the fastener receiver 44 can be a lockwasher and nut combination, a “J” nut, a “U” nut, or the like.

The internal stop 38 can also prevent the extension 26 from moving more than desired when a force or torque is applied to the front end module 14. Thus, as force is applied to the front end module 14, the extension 26 will move inside the connector 20. The internal stop 38 prevents the extension 26 from moving more than desired when a force is applied to the front end module 14, such as but not limited to, during a collision. When the internal stop 38 prevents the extension 26 from moving, the internal stop 38 also causes the front end module 14 to fold and absorb the stress applied from the force rather than the front end module 14 breaking.

It should be appreciated that any type of connector between the body 12 and the front end module 14 can be used, either a mechanical connection, a welding connection, an adhesive connection, or the like, when a flat surface, such as the connection area 28 or extension 26 contacting the internal stop 38 is used, which allows for an adequate surface area at the connection point between the extension 24, 26 and connector 20, 22. Therefore, any stress applied to the connection point will be sufficiently distributed.

The connection point between the body 12 and the front end module 14 can be made of metal. The remaining portions of the body 12 and the front end module 14 can be made of metal or composite material. By having the connection points made of metal, the body 12 and the front end module 14 better absorb energy when a force is applied to the front end module 14 then if the connection points were made of a composite material. The reason for this is because as energy or torque is applied metal will fold upon itself, whereas a composite material is more likely to break.

The remaining portions of the front end module 14, other than the connection point described above, can be made of a composite material. The reason for this is because the strength to weight ratio of a composite material is much better than the strength to weight ratio of a metal. Composite material can be used because the weight added for the additional reinforcement is less than the weight if a metal was used. Further, the strength of the composite material to withstand the torque or force being applied during a collision or the like is sufficient. Thus, the reduction in weight added when a composite material is used rather than a metal material allows the vehicle 10 to have better gas mileage along with other benefits of having a lighter vehicle. By way of explanation and not limitation, a composite material that can be used is a thermoset material or a thermoplastic material. A thermoset material is a softer material than a thermoplastic material, which typically results in the thermoset material absorbing energy better than a thermoplastic material.

The reinforcement member 16 can be molded or integrated with the front end module 14, such that the reinforcement member 16 and the front end module 14 are one piece. Alternatively, the front end module 14 and the reinforcement member 16 can be formed separately and then connected by a fastener device (not shown), welding, or the like. By having the front end module 14 and the reinforcement member 16 formed as a single piece, the manufacturing process is more efficient since a connection step is removed from the manufacturing process when compared to when the front end module 14 and reinforcement member 16 are formed separately and later connected.

By way of explanation and not limitation, in operation when a force is applied to the vehicle 10 such as, but not limited to, during a collision the extensions 24, 26 will act to absorb frontal crash energy prior to the impact load from the force reaching the section of the body 12 supported by the upper front cross car segment 18. Also, the body 12 has crush rails 42, which can also absorb at least a portion of the frontal crash energy. Further, the extensions 24, 26 distribute some of the torque applied during the collision to other areas, such as A-pillars (not shown), that would not otherwise have an amount of torque applied to them during a front end collision.

The extensions 24, 26 can have bumper initiators 48 to aid in the absorption of frontal crash energy. Bumper initiators 48 can be alterations in the structure which encourage the structure to fold rather than break during a collision. The bumper initiators 48 can be anywhere on the front end module 14 where it would be ideal for the structure of the front end module 14 to fold upon itself. If the front end module 14 is made of metal then the bumper initiators 48 are corrugations in the structure. If the front end module 14 is made of composite material then the bumper initiators 48 are a cone shape. However, it is within the scope of the present invention that the bumper initiators 48 can be any shape or alteration in the structure of the front end module 14 that will cause the front end module 14 to fold upon itself when a sufficient force is applied.

The description of the invention is merely exemplary in nature and, thus, variations that do not depart from the gist of the invention are intended to be within the scope of the invention. Such variations are not to be regarded as a departure from the spirit and scope of the invention.

1. A vehicle assembly front end module for absorbing crash energy comprising:
a body having at least one connector;
a front end module;
a reinforcement member connected to said front end module having at least one extension configured to absorb crash energy; and
one or more bumper initiators formed on said front end module for aiding in the absorption of crash energy, said at least one extension being smaller in cross section than said at least one connector, and at least a portion of said at least one extension slides into said at least one connector during the connection of said at least one extension and said at least one connector .

2. The front end module of claim 1, wherein said extension and said connector each include a connection area, wherein said connection area of said extension connects to said connection area of said connector.

3. The front end module of claim 2 further comprising at least one fastener extending through said connection area of said connector and said connection area of said extension and securing said extension to said connector.

4. The front end module of claim 1, wherein said connector is adapted to receive at least a portion of said extension.

5. The front end module of claim 4, wherein said connector includes an internal stop.

6. The front end module of claim 1, further comprising at least one fastener extending through said connector and said extension.

7. (canceled)

8. The front end module of claim 1 further comprising a crash rail connected to said body, wherein said crash energy is absorbed by said crash rail.

9. The front end module of claim 1 wherein said reinforcement member is integrated with said front end module.

10. A vehicle assembly front for absorbing crash energy comprising:
a body having at least one connector;
a front end module;
a reinforcement member connected to said front end module having at least one extension;
at least one connection area on said connector and at least one connection area on said extension configured to absorb crash energy; and
one or more bumper initiators formed on said front end module for aiding in the absorption of crash energy, said at least one extension is smaller in cross section than said at least one extension, and at least a portion of said at least one extension slides into said at least one connector as said at least one connection area of said connector connects to said at least one connection area of said extension.

11. The front end module of claim 10 further comprising at least one fastener extending through said connection area of said connector and said connection area of said extension.

12. (canceled)

13. The front end module of claim 10 further comprising a crash rail connected to said body, wherein said crash energy is absorbed by said crash rail.

14. The front end module of claim 10, wherein said reinforcement member is integrated with said front end module.

15. A vehicle assembly for absorbing crash energy comprising:
a body having at least one connector;
a front end module;
a reinforcement member connected to said front end module having at least one extension configured to absorb crash energy; and
one or more bumper initiators formed on said front end module for aiding in the absorption of crash energy, said at least one extension being smaller in diameter than said at least one connector, and said at least one connector adapted to receive at least a portion of said at least one extension such that at least a portion of said at least one extension slides into said at least one connector during connection of said at least one extension and said at least one connector.

16. The front end module of claim 15, wherein said connector includes an internal stop.

17. The front end module of claim 15 further comprising at least one fastener extending through said connector and said extension.

18. (canceled)

19. The front end module of claim 15 further comprising a crash rail connected to said body, wherein said crash energy is absorbed by said crash rail.

20. The front end module of claim 15 wherein said reinforcement member is integrated with said front end module.
